(19) United States
(12) Patent Application Publication
(10) Pub. No.: US 2012/0028094 A1
(43) Pub. Date: Feb. 2, 2012

(54) BATTERY PACK

(76) Inventors: Yongsam KIM, Yongin-si (KR); Byungkyu AHN, Yongin-si (KR)

(21) Appl. No.: 13/009,770

(22) Filed: Jan. 19, 2011

Related U.S. Application Data
(60) Provisional application No. 61/368,043, filed on Jul. 27, 2010.

(51) Int. Cl. H01M 2/10

(52) U.S. Cl. 429/99

(57) ABSTRACT

A battery pack including a battery cell including an electrode assembly, and a case accommodating the electrode assembly therein and including an end wall at a first end, a side wall connected to the end wall and extending toward a second end opposite the first end, and a rounded portion connected between the end wall and the side wall; and an insulation member including a first portion and a second portion, the first portion being on the side wall of the case, and the second portion at least partially covering the rounded portion, an end of the second portion of the insulation member being on the rounded portion.

### CROSS-REFERENCE TO RELATED APPLICATION

This application claims the benefit of U.S. Provisional Application No. 61/368,043, filed on Jul. 27, 2010 in the United States Patent and Trademark Office, the disclosure of which is incorporated herein in its entirety by reference.

### BACKGROUND

1. Field

Aspects of embodiments of the present invention relate to a battery pack.

2. Description of the Related Art

Secondary batteries are rechargeable, and thus, can be repeatedly used. Such a secondary battery may be manufactured as a battery pack including at least one battery cell.

The battery pack may be used in portable small devices such as cellular phones, notebooks, computers, cameras, and camcorders, or be used as a power source for driving a motor, e.g., of high output hybrid electric vehicles (HEV), electric vehicles (EV), and electric scooters.

As such, since the battery pack is installed on an external electronic device, the battery cell is required to have an insulation characteristic to prevent an undesirable short circuit between the battery cell and an external electronic device.

### SUMMARY

According to an aspect of embodiments of the present invention, a battery pack provides an insulation characteristic of a battery cell by preventing or substantially preventing an end of an insulation member from being caught and damaged by a partition wall when the battery cell is inserted in a space of a frame. According to another aspect of embodiments of the present invention, a battery pack includes a battery cell having an edge portion wrapped by an insulation member. According to another aspect of embodiments of the present invention, a battery pack provides a robust insulation member between a battery cell and an adjacent wall of a frame.

According to an embodiment of the present invention, a battery pack includes a battery cell including an electrode assembly, and a case accommodating the electrode assembly therein and including an end wall at a first end, a side wall connected to the end wall and extending toward a second end opposite the first end, and a rounded portion connected between the end wail and the side wall; and an insulation member including a first portion and a second portion, the first portion being on the side wall of the case, and the second portion at least partially covering the rounded portion, an end of the second portion of the insulation member being on the rounded portion.

In one embodiment, a battery pack further includes at least one partition wall adjacent the battery cell. The insulation member may include an electrically insulative heat shrinkage material. The insulation member may include at least one selected from the group consisting of polycarbonate (PC), polypropylene (PP), polyethylene (PE), and polyethylene terephthalate (PET). The insulation member may further include ceramic particles.

In one embodiment, the side wall of the case includes at least one first side wall and at least one second side wall connected to the at least one first side wall, and the insulation member has a tubular shape and continuously surrounds the at least one first side wall and the at least one second side wall.

The insulation member may have a thickness of about 0.05 mm to about 0.3 mm. The rounded portion may have a radius of curvature of about 1 mm to about 8 mm. An outer surface at the end of the insulation member and an outer surface of the end wall may be substantially coplanar. The rounded portion may protrude toward an exterior of the case.

In one embodiment, the rounded portion includes a first rounded portion end directly connected to the side wall and a second rounded portion end directly connected to the end wall, an outer surface of the second rounded portion end being coplanar with an outer surface of the end wall.

The rounded portion may protrude toward an interior of the case. In one embodiment, the first portion of the insulation member includes a planar portion, and the second portion of the insulation member includes a rounded portion. The first and second portions of the insulation member may include a single integral member or separate portions. In one embodiment, the insulation member is not on the end wall. A battery pack may further include a cooling plate contacting the end wall of the case.

According to another embodiment of the present invention, a battery pack includes a battery cell including an electrode assembly, and a case accommodating the electrode assembly therein and including an end wall at a first end, a side wall connected to the end wall and extending toward a second end opposite the first end, and a rounded portion connected between the end wall and the side wall; and an insulation member on the side wall of the case and at least partially covering the rounded portion, an outer surface of the insulation member and an outer surface of the end wall being substantially coplanar.

In one embodiment, a distance from an outer surface of the side wall to an end of the insulation member at the first end is less than or equal to 10% of a distance from the outer surface of the side wall to a central axis of the case extending between the first and second ends.

In one embodiment, the case further includes an extension portion connected between the rounded portion and the end wall and including an outer surface substantially parallel to and spaced apart from an outer surface of the end wall, the insulation member at least partially covering the extension portion.

In one embodiment, a battery pack further includes at least one partition wall adjacent the battery cell. The battery pack may further include a cooling plate contacting the end wall of the case. The insulation member may extend into a space between the rounded portion and the cooling plate.

According to another embodiment of the present invention, a battery pack includes; at least one battery cell including a case accommodating an electrode assembly; and an insulation member surrounding side surfaces of the case, wherein the insulation member extends to cover a round part formed between a lower surface and the side surfaces the case.

According to an aspect of embodiments of the present invention, a battery pack includes an insulation member having an end disposed at a round part of a case, and thus, the end of the insulation member is prevented or substantially prevented from being caught and damaged by a partition wall when a battery cell is inserted in a space of a frame.

According to another aspect of embodiments of the present invention, a battery pack ensures an insulation characteristic of the battery cell to prevent or substantially prevent an undesirable short circuit between the battery cell and an external electronic device.

### BRIEF DESCRIPTION OF THE DRAWINGS

The above and other features and advantages will become more apparent to those of ordinary skill in the art by describing in detail some exemplary embodiments of the present invention with reference to the attached drawings. Moreover, additional aspects and/or advantages of embodiments of the present invention are set forth in the following description and accompanying drawings, or may be obvious in view thereof to those skilled in the art.

FIG. 1 is a perspective view illustrating a battery pack according to an embodiment of the present invention.

FIG. 2 is an exploded perspective view illustrating a battery cell and a frame of the battery pack of FIG. 1.

FIG. 3 is an exploded perspective view illustrating a battery cell and an insulation member of the battery pack of FIG. 1.

FIG. 4 is a partial cross-sectional view illustrating a lower portion of the battery pack of FIG. 1.

FIG. 5 is an enlarged partial cross-sectional view illustrating a case of a battery cell and an insulation member of the battery pack of FIG. 4.

FIG. 6 is a partial cross-sectional view illustrating an insulation member of a battery pack according to an embodiment of the present invention.

FIG. 7 is a partial cross-sectional view illustrating a lower portion of a battery pack according to another embodiment of the present invention.

FIG. 8 is an enlarged partial cross-sectional view illustrating a case of a battery cell and an insulation member of the battery pack of FIG. 7.

FIG. 9 is a partial cross-sectional view illustrating a lower portion of a battery pack according to another embodiment of the present invention.

FIG. 10 is an enlarged partial cross-sectional view illustrating a case of a battery cell and an insulation member of the battery pack of FIG. 9.

### DESCRIPTION OF REFERENCE NUMERALS INDICATING SOME ELEMENTS IN THE DRAWINGS

100: Battery pack
110: Battery cell
120, 220, 320: Insulation member
130: Frame
140: Cooling plate

### DETAILED DESCRIPTION

Some exemplary embodiments of the present invention will now be described with reference to the accompanying drawings; however, embodiments of the present invention may be embodied in different forms and should not be construed as limited to the exemplary embodiments illustrated and set forth herein. Rather, these exemplary embodiments are provided by way of example for understanding of the invention and to convey the scope of the invention to those skilled in the art. As those skilled in the art would realize, the described embodiments may be modified in various different ways, all without departing from the spirit or scope of the present invention. Like reference numerals designate like elements throughout the specification and drawings.

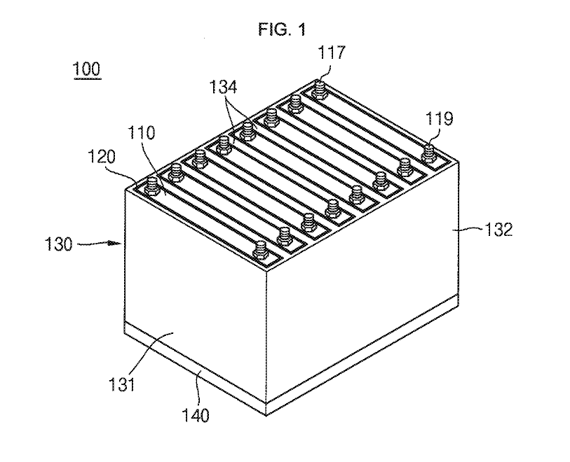

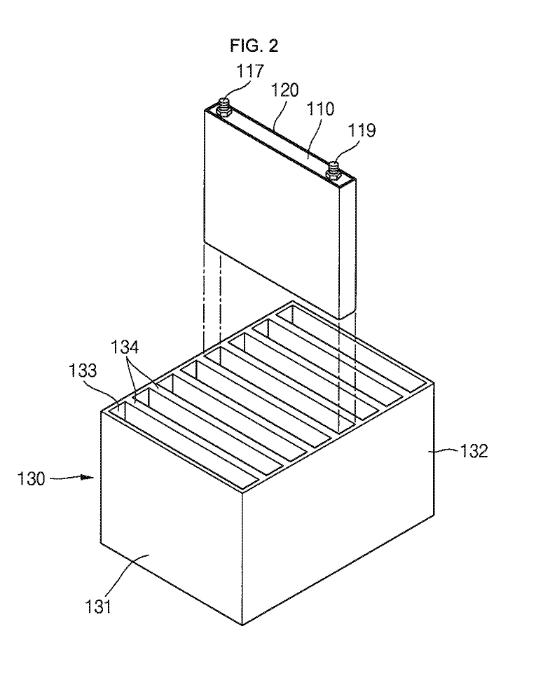

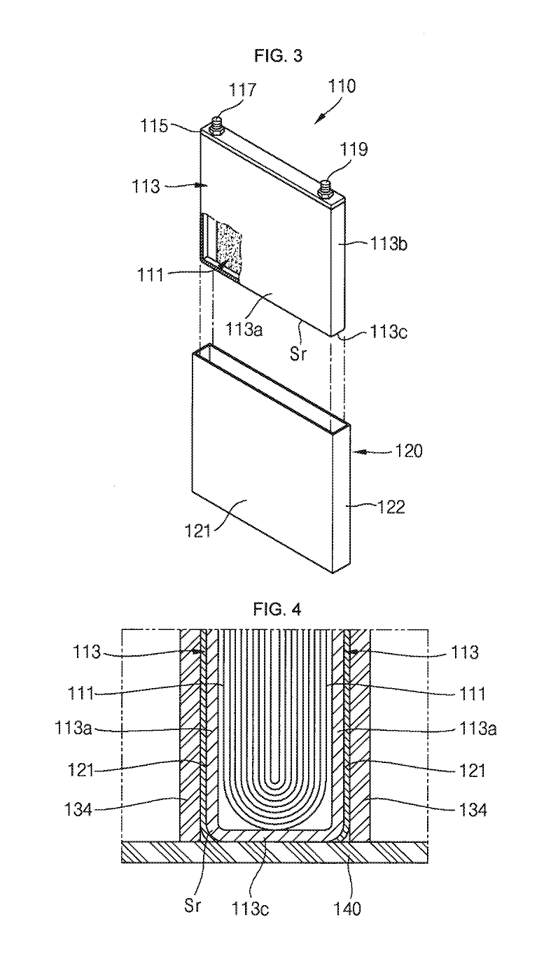

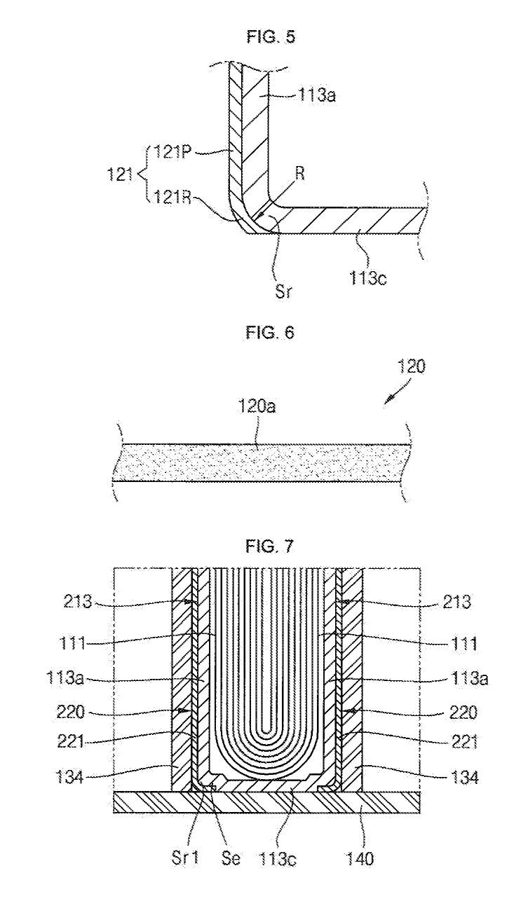

FIG. 1 is a perspective view illustrating a battery pack according to an embodiment of the present invention. FIG. 2 is an exploded perspective view illustrating a battery cell and a frame of the battery pack of FIG. 1. FIG. 3 is an exploded perspective view illustrating the battery cell and an insulation member of the battery pack of FIG. 1. FIG. 4 is a partial cross-sectional view illustrating a lower portion of the battery pack of FIG. 1. FIG. 5 is an enlarged partial cross-sectional view illustrating a case of the battery cell and an insulation member of the battery pack of FIG. 4. FIG. 6 is a partial cross-sectional view illustrating an insulation member of a battery pack according to an embodiment of the present invention.

Referring to FIGS. 1 through 6, a battery pack 100 according to an embodiment of the present invention includes at least one battery cell 110, an insulation member 120, a frame 130, and a cooling plate 140.

The battery cell 110, in one embodiment, includes an electrode assembly 111 including a positive electrode plate and a negative electrode plate with a separator therebetween, a case 113 having a space accommodating the electrode assembly 111 and electrolyte, a cap assembly 115 coupled to the case 113 and sealing the case 113, a positive electrode terminal 117 electrically connected to the positive electrode plate and protruding out of the cap assembly 115, and a negative electrode terminal 119 electrically connected to the negative electrode plate and protruding out of the cap assembly 115. The case 113 may have an open upper portion to receive the electrode assembly 111, and include a pair of first side surfaces 113a, a pair of second side surfaces 113b, and a lower surface 113c. The first side surfaces 113a may be long side surfaces having a large width, and the second side surfaces 113b may be short side surfaces connected between the first side surfaces 113a and having a width smaller than the width of the first side surfaces 113a. The lower surface 113c may be connected to the first and second side surfaces 113a and 113b. The case 113 may be formed by performing a deep drawing operation on a metal plate, and a round part Sr protruding outward at connections between the first and second side surfaces 113a and 113b and the lower surface 113c may be formed while forming the case 113.

The battery cell 110 may be connected to an external electronic device to perform a discharging operation for supplying power, or may perform a charging operation for receiving power from an external electronic device.

The insulation member 120, in one embodiment, surrounds side surfaces of the battery cell 110, that is, the first and second side surfaces 113a and 113b of the case 113. For example, the insulation member 120 may have a single body tube shape to continuously surround the first and second side surfaces 113a and 113b of the case 113. That is, the insulation member 120 may be formed as a single seamless part and having a hollow elongated shape. The insulation member 120 extends such that the insulation member 120 covers at least a portion of the round part Sr of the case 113 and does not cover the lower surface 113c. Accordingly, in one embodiment, a lower end of the insulation member 120 is disposed between a start portion and an end portion of the round part Sr. The start portion of the round part Sr is a portion where the first and second side surfaces 113a and 113b meet, or connect with, the round part Sr, and the end portion of the round part Sr is a portion where the lower surface 113c meets, or connects with, the round part Sr. In addition, in one embodiment, the lower end of the insulation member 120 and the lower surface 113c are disposed in the same plane.

The insulation member 120 prevents or substantially prevents an undesirable short circuit that may be formed between the battery cell 110 and an external electronic device. When the battery cell 110 is inserted in a space 133 of the frame 130, the insulation member 120 prevents or substantially prevents an end of the insulation member 120 from being caught by a partition wall 134, and allows heat generated from the battery cell 110 to be emitted through the lower surface 113c of the case 113.

In one embodiment, the insulation member 120 includes a first insulation side surface 121 and a second insulation side surface 122. The first insulation side surface 121 may be a long side surface that corresponds to the first side surface 113a and extends to the round part Sr, and the second insulation side surface 122 may be a short side surface that corresponds to the second side surface 113b and extends to the round part Sr. The insulation member 120 accommodating the battery cell 110 may be closely adhered to the battery cell 110 through a heating process. In one embodiment, in the heating process, heat is applied to the second side surface 113b and the round part Sr. This is because the first insulation side surface 121 may be uneven if heat is applied to the first side surface 113a, by way of example. In a case where the first insulation side surface 121 is uneven, when the battery cell 110 is inserted in the space 133 of the frame 130, the first insulation side surface 121 closely adhered to the first side surface 113a unevenly contacts the partition wall 134 of the frame 130, and a heat emission efficiency of the battery cell 110 through the frame 130 may be degraded.

A close adhesion between the insulation member 120 and the case 113 will now be described with respect to the first insulation side surface 121 and the first side surface 113a. Since a close adhesion between the second insulation side surface 122 and the second side surface 113b is the same as that between the first insulation side surface 121 and the first side surface 113a, a description thereof will be omitted.

Referring to FIGS. 4 and 5, the first insulation side surface 121 is closely adhered to the first side surface 113a such that the lower end of the first insulation side surface 121 is disposed at the round part Sr. In one embodiment, the first insulation side surface 121 includes a first insulation planar part 121P closely adhered to the first side surface 113a, and a first insulation round part 121R closely adhered to the round part Sr. The round part Sr, in one embodiment, has a radius of curvature R ranging from about 1 mm to about 8 mm. When the radius of curvature R of the round part Sr is less than 1 mm, a space for forming the first insulation round part 121R is reduced, and it is difficult to dispose the first insulation round part 121R at the lower surface 113c of the case 113. In this case, when the battery cell 110 is inserted in the space 133 of the frame 130, the end of the first insulation side surface 121 comes closer to the partition wall 134, and thus, is more easily caught by the partition wall 134. When the radius of curvature R of the round part Sr is greater than 8 mm, a dead space formed between the electrode assembly 111 and the case 113 in the inner space of the case 113 is increased.

The insulation member 120 may be formed of an electrically insulative heat shrinkage material, for example, at least one of polycarbonate (PC), polypropylene (PP), polyethylene (PE), and polyethyeleneterepthalate (PET). In one embodiment, as illustrated in FIG. 6, the insulation member 120 may be formed by adding a material having heat conductivity, such as ceramic particles 120a, to at least one of polycarbonate (PC), polypropylene (PP), polyethylene (PE), and polyethyeleneterepthalate (PET) to easily emit heat from the battery cell 110.

In one embodiment, the insulation member 120 may have a thickness ranging from about 0.05 mm to about 0.3 mm. The insulation member 120 having a thickness of less than 0.05 mm is difficult to form through an injection process, and the insulation member 120 having a thickness greater than 0.3 mm increases the entire thickness of the secondary battery 100.

The frame 130, in one embodiment, includes a pair of first support plates 131, a pair of second support plates 132 connecting the first support plates 131, and one or more of the partition walls 134 for forming the space 133 in which the battery cell 110 is inserted. The partition walls 134 may be parallel or substantially parallel to the first support plates 131. The frame 130, in one embodiment, is formed of a metal such as aluminum, and emits heat generated from the battery cell 110 to the outside.

The cooling plate 140, in one embodiment, is coupled to and contacts a lower portion of the frame 130. Further, in one embodiment, the cooling plate 140 contacts a lower portion of the battery cell 110 inserted in the space 133 of the frame 130, for example, the lower surface 113c of the case 113. The cooling plate 140, in one embodiment, accommodates a cooling water passage and is formed of a metal, so that the cooling water can remove heat generated from the battery cell 110 or heat transferred through the frame 130 from the battery cell 110. Although not shown, the cooling plate 140 may be connected to a cooling water supply device for supplying cooling water.

As described above, since the battery pack 100 includes the insulation member 120 with an end disposed at the round part Sr of the case 113, the insulation member 120 is prevented or substantially prevented from being caught and damaged by the partition wall 134 when the battery cell 110 is inserted in the space 133 of the frame 130.

Thus, the battery pack 100 ensures an insulation characteristic of the battery cell 110 to prevent or substantially prevent an undesirable short circuit between the battery cell 110 and an external electronic device.

A battery pack according to another embodiment of the present invention will now be described.

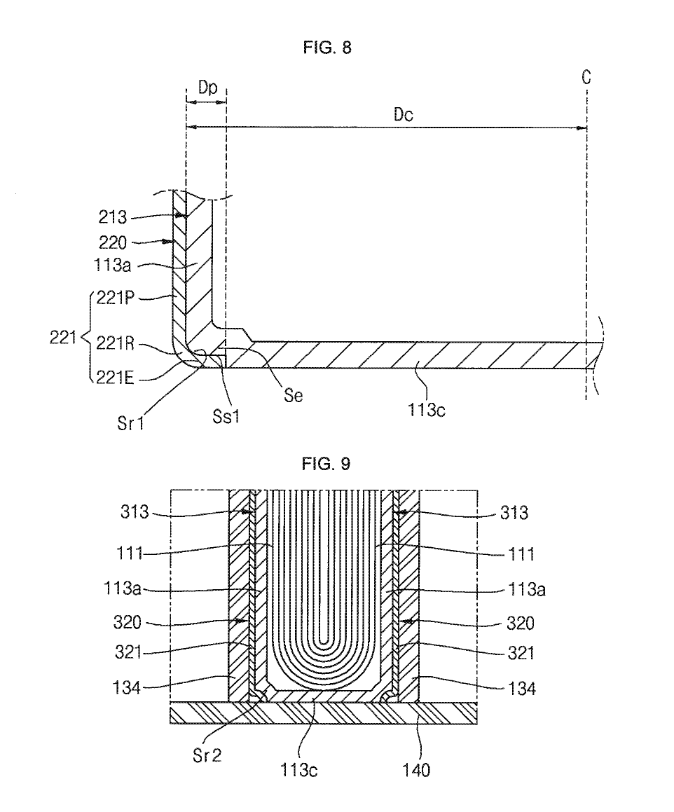

FIG. 7 is a partial cross-sectional view illustrating a lower portion of a battery pack according to another embodiment of the present invention, the partial cross-section view corresponding to that of FIG. 4. FIG. 8 is an enlarged partial cross-sectional view illustrating a case of a battery cell and an insulation member of the battery pack of FIG. 7.

The battery pack according to the embodiment of FIGS. 7 and 8 is the same in configuration and function as the battery pack 100 of FIG. 1 except for a case 213 and an insulation member 220. Thus, an illustration and a description of the same configuration will be omitted, and the case 213 and the insulation member 220 will be principally described.

Referring to FIGS. 7 and 8, the case 213 is similar to the case 113 described above and illustrated in FIGS. 3 and 4. However, the case 213 includes an extension part Se as well as a round part Sr1 protruding outward between the lower surface 113c and the first and second side surfaces 113a and 113b. The extension part Se extends in parallel or substantially in parallel to the lower surface 113c of the case 213 from the round part Sr1, and is disposed at a higher position than the lower surface 113c of the case 213. Accordingly, a receiving space Ss1, or accommodation space, is formed between the first side surface 113a and the lower surface 113c of the case 213 to receive the insulation member 220 at the outside of the extension part Se. A distance Dp between the first side surface 113a and the lower surface 113c may be equal to or less than 10% of a distance Dc between a central axis C and the first side surface 113a of the case 213. This is because heat generated from the battery cell 110 that is being emitted through the lower surface 113c of the case 213 may be reduced if the distance Dp is greater than 10% of the distance Dc.

In one embodiment, the insulation member 220 has a first insulation side surface 221 and a second insulation side surface (not shown), which are similar to the first and second insulation side surfaces 121 and 122 described above and illustrated in FIGS. 3 and 4. However, the first insulation side surface 221 may be a long side surface that corresponds to the first side surface 113a and passes by the round part Sr and extends to the accommodation space Ss1, and the second insulation side surface (not shown) may be a short side surface that corresponds to the second side surface 113b (refer to FIG. 3) and passes by the round part Sr and extends to the accommodation space Ss1. Hereinafter, among the first insulation side surface 221 and the second insulation side surface (not shown), the first insulation side surface 221 will now be described in further detail, by way of example.

The first insulation side part 221 has a lower end that is disposed in the accommodation space Ss1 of the case 213. In one embodiment, the first insulation side surface 221 includes a first insulation planar part 221P closely adhered to the first side surface 113a, a first insulation round part 221R closely adhered to the round part Sr1, and a first insulation extension part 221E accommodated in the accommodation space Ss1.

Since the second insulation side surface (not shown) may be the same as the first insulation side surface 221 except for its width, a description thereof will be omitted.

As described above, since the insulation member 220 of the battery pack according to the embodiment shown in FIGS. 7 and 8 is accommodated in the accommodation space Ss1 of the case 213 such that the insulation member 220 is stably disposed at the lower side of the case 213, the end of the insulation member 220 is effectively prevented or substantially prevented from being caught and damaged by the partition wall 134 when the battery cell 110 is inserted in the space 133 of the frame 130, and heat generated from the battery cell 110 is emitted through the lower surface 113c of the case 213.

Thus, the battery pack described above according to an embodiment of the present invention effectively ensures an insulation characteristic of the battery cell 110 to prevent or substantially prevent an undesirable short circuit between the battery cell 110 and an external electronic device.

A battery pack according to another embodiment of the present invention will now be described.

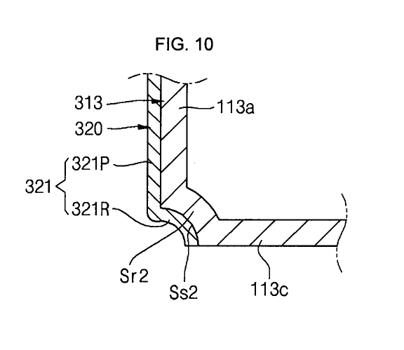

FIG. 9 is a partial cross-sectional view illustrating a lower portion of a battery pack according to another embodiment of the present invention, the partial cross-sectional view corresponding to that of FIG. 4. FIG. 10 is an enlarged partial cross-sectional view illustrating a case of a battery cell and an insulation member of the battery pack of FIG. 9.

The battery pack according to the embodiment of FIGS. 9 and 10 is the same in configuration and function as the battery pack 100 of FIG. 1 except for a case 313 and an insulation member 320. Thus, an illustration and a description of the same configuration will be omitted, and the case 313 and the insulation member 320 will be principally described.

Referring to FIGS. 9 and 10, the case 313 is similar to the case 113 described above and illustrated in FIGS. 3 and 4. However, the case 313 includes a round part Sr2 between the lower surface 113c and each of the first and second side surfaces 113a and 113b, and the round part Sr2 protrudes to the inside of the case 313. Accordingly, an accommodation space Ss2, which accommodates the insulation member 320 at the outside of the round part Sr2 between the lower surface 113c and each of the first and second side surfaces 113a and 113b is formed.

In detail, the insulation member 320 has a first insulation side surface 321 and a second insulation side surface (not shown), which are similar to the first and second insulation side surfaces 121 and 122 described above and illustrated in FIGS. 3 and 4. However, the first insulation side surface 321 may be a long side surface that corresponds to the first side surface 113a and extends to be accommodated in the accommodation space Ss2, and the second insulation side surface (not shown) may be a short side surface that corresponds to the second side surface 113b (refer to FIG. 3) and extends to be accommodated in the accommodation space Ss2. Hereinafter, among the first insulation side surface 321 and the second insulation side surface (not shown), the first insulation side surface 321 will now be described in further detail, by way of example.

The first insulation side part 321 has a lower end that is disposed in the accommodation space Ss2. In one embodiment, the first insulation side surface 321 includes a first insulation planar part 321P closely adhered to the first side surface 113a, and a first insulation round part 321R accommodated in the accommodation space Ss2.

Since the second insulation side surface (not shown) may be the same as the first insulation side surface 321 except for its width, a description thereof will be omitted.

As described above, since the insulation member 320 of the battery pack according to the embodiment of FIGS. 9 and 10 is accommodated in the accommodation space Ss2 of the case 313 such that the insulation member 320 is stably disposed at the lower side of the case 313, the end of the insulation member 320 is effectively prevented or substantially prevented from being caught and damaged by the partition wall 134 when the battery cell 110 is inserted in the space 133 of the frame 130, and heat generated from the battery cell 110 is emitted through the lower surface 113c of the case 313.

Thus, the battery pack described above according to an embodiment of the present invention effectively ensures an insulation characteristic of the battery cell 110 to prevent or substantially prevent an undesirable short circuit between the battery cell 110 and an external electronic device.

Some exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A battery pack comprising:
a battery cell comprising:
an electrode assembly; and
a case accommodating the electrode assembly therein and comprising an end wall at a first end, a side wall connected to the end wall and extending toward a second end opposite the first end, and a rounded portion connected between the end wall and the side wall; and
an insulation member comprising a first portion and a second portion, the first portion being on the side wall of the case, and the second portion at least partially covering the rounded portion,
wherein an end of the second portion of the insulation member is on the rounded portion.

2. The battery pack of claim 1, further comprising at least one partition wall adjacent the battery cell.

3. The battery pack of claim 1, wherein the insulation member comprises an electrically insulative heat shrinkage material.

4. The battery pack of claim 1, wherein the insulation member comprises at least one selected from the group consisting of polycarbonate (PC), polypropylene (PP), polyethylene (PE), and polyethylene terephthalate (PET).

5. The battery pack of claim 4, wherein the insulation member further comprises ceramic particles.

6. The battery pack of claim 1, wherein the side wall of the case comprises at least one first side wall and at least one second side wall connected to the at least one first side wall, and wherein the insulation member has a tubular shape and continuously surrounds the at least one first side wall and the at least one second side wall.

7. The battery pack of claim 1, wherein the insulation member has a thickness of about 0.05 mm to about 0.3 mm.

8. The battery pack of claim 1, wherein the rounded portion has a radius of curvature of about 1 mm to about 8 mm.

9. The battery pack of claim 1, wherein an outer surface at the end of the insulation member and an outer surface of the end wall are substantially coplanar.

10. The battery pack of claim 1, wherein the rounded portion protrudes toward an exterior of the case.

11. The battery pack of claim 1, wherein the rounded portion comprises a first rounded portion end directly connected to the side wall and a second rounded portion end directly connected to the end wall, an outer surface of the second rounded portion end being coplanar with an outer surface of the end wall.

12. The battery pack of claim 1, wherein the rounded portion protrudes toward an interior of the case.

13. The battery pack of claim 1, wherein the first portion of the insulation member comprises a planar portion, and the second portion of the insulation member comprises a rounded portion.

14. The battery pack of claim 1, wherein the first and second portions of the insulation member comprise a single integral member or separate portions.

15. The battery pack of claim 1, wherein the insulation member is not on the end wall.

16. The battery pack of claim 1, further comprising a cooling plate contacting the end wall of the case.

17. A battery pack comprising:
a battery cell comprising:
an electrode assembly; and
a case accommodating the electrode assembly therein and comprising an end wall at a first end, a side wall connected to the end wall and extending toward a second end opposite the first end, and a rounded portion connected between the end wall and the side wall; and
an insulation member on the side wall of the case and at least partially covering the rounded portion,
wherein an outer surface of the insulation member and an outer surface of the end wall are substantially coplanar.

18. The battery pack of claim 17, wherein a distance from an outer surface of the side wall to an end of the insulation member at the first end is less than or equal to 10% of a distance from the outer surface of the side wall to a central axis of the case extending between the first and second ends.

19. The battery pack of claim 17, wherein the case further comprises an extension portion connected between the rounded portion and the end wall and including an outer surface substantially parallel to and spaced apart from an outer surface of the end wall, the insulation member at least partially covering the extension portion.

20. The battery pack of claim 17, further comprising at least one partition wall adjacent the battery cell.

21. The battery pack of claim 20, further comprising a cooling plate contacting the end wall of the case.

22. The battery pack of claim 21, wherein the insulation member extends into a space between the rounded portion and the cooling plate.
